(19) United States
(12) Patent Application Publication
(10) Pub. No.: US 2004/0268084 A1
(43) Pub. Date: Dec. 30, 2004

(54) Protected RAM filesystem

(76) Inventors: Steve Longerbeam, San Jose, CA (US); Matthew Aaron Locke, Milpitas, CA (US); Kevin Dale Morgan, San Francisco, CA (US)

Correspondence Address: Finnegan, Henderson, Farabow,, Garrett & Dunner, L.L.P., 1300 I Street, N.W., Washington, DC, 20005-3315, US

(21) Appl. No.: 10/611,461

(22) Filed: Jun. 30, 2003

(51) Int. Cl. G06F 12/08; G06F 12/14

(52) U.S. Cl. 711/206; 711/163

(57) ABSTRACT

Disclosed is a computing system comprising at least one random access memory (RAM) and a processor. The RAM includes a storage location containing filesystem data with associated page table entries, and each page table entry includes a read/write flag for the filesystem data. The filesystem data is initially mapped for read-only access. The processor is configured to remap the filesystem data for write access by modifying the read/write flag of the page table entries; to perform a write operation on the filesystem data in write access, and to remap the filesystem data back for read-only access by modifying the read/write flag of the page table entries. The computing system also uses filesystem that is mounted in the RAM to manage filesystem data. The filesystem protects the filesystem data from errant writes by modifying page table entries associated with the filesystem data without using a disk cache.

### FIELD

The present invention relates generally to computing systems and, more particularly, to computing systems protecting filesystem data from corruption by errant writes in an operating system or kernel. Specifically, the present invention relates to a protected random access memory (RAM) filesystem.

### BACKGROUND

Personal computing systems operate with one or more operating systems. The operating system kernel (“kernel”) is the central component of the operating system, and commonly referred to as the operating system. The kernel is loaded into a random access memory (RAM) when a computing system boots, and is responsible for critical procedures that are needed for the computing system to operate. One critical responsibility of the kernel is to manage filesystem data for the computing system. Typically, a filesystem includes a plurality of data files forming a directory tree partitioned on a hard disk. For instance, the filesystem can include a root directory with one or more subdirectories, each subdirectory containing one or more data files storing information. The kernel is thus responsible for granting read and write access to the data files or file directories, and therefore file and directory operations are performed in kernel mode for the computing system.

One popular kernel is the Linux kernel. It uses a data structure, such as an “node,” to handle and manage file system data for a filesystem. It also operates with a virtual filesystem (VFS) layer in managing multiple types of filesystems that can be mounted within a computing system. A common concern in such an environment is protection of filesystem data. An approach that is available in a conventional Linux environment is using a write-protected, RAM block device driver in which a filesystem can be mounted on a block device. A disadvantage with this approach is that it makes use of disk caches for temporarily storing of filesystem data.

Using disk caches, however, exposes filesystem data to errant writes by the operating system or kernel. For instance, if a defective operating system has access to inodes, the operating system may perform an inappropriate “write” to filesystem data that may corrupt information in an associated file. As a result, filesystem data relating to a file containing such information may be corrupted. The corruption of such information may require developers of defective operating systems to recall the operating systems for replacement or provide software updates for the defective operating systems, which are both expensive and time intensive to implement.

Other types of filesystems such as EXT2 and EXT3 are designed for optimum performance on disk-based media. These filesystems implement features as block groups on the disk media. In particular, inode data is grouped into contiguous sets of data blocks to minimize disk seeks when accessing files. On RAM-based filesystems, however, there is no performance penalty when randomly seeking data, so block groups are not needed. By omitting such features, a RAM-based filesystem can make more efficient use of filesystem memory space.

There exists, therefore, a need to provide RAM-based filesystem that protects filesystem data from corruption by errant writes in an operating system or kernel without using disk caches.

### SUMMARY

According to one aspect of the invention, a computing system comprises at least one random access memory (RAM) and a processor. The RAM includes a storage location containing filesystem data with associated page table entries, and each page table entry includes a read/write flag for the filesystem data. The filesystem data is initially mapped for read-only access. The processor is configured to remap the filesystem data for write access by modifying the read/write flag of the page table entries; to perform a write operation on the filesystem data during write access, and to remap the filesystem data back for read-only access by modifying the read/write flag of the page table entries.

According to another aspect of the invention, a computing system comprises at least one random access memory (RAM) and a filesystem. The filesystem is mounted in the RAM to manage filesystem data. The filesystem protects the filesystem data from errant writes by modifying page table entries associated with the filesystem data without using a disk cache.

Other features and advantages will be apparent from the accompanying drawings, and from the detailed description, which follows below.

### BRIEF DESCRIPTION OF THE DRAWINGS

The accompanying drawings, which are incorporated in, and constitute a part of this specification illustrate exemplary embodiments and implementations and, together with the description, serve to explain the principles of the invention. In the drawings,

FIG. 1 illustrates an exemplary computing system for providing a protected RAM filesystem;

FIG. 2 illustrates one example of a random access memory (RAM) for the computing system of FIG. 1 having a protected RAM filesystem;

FIG. 3A illustrates one detailed example of the protected RAM filesystem of FIG. 2 partitioned with various object blocks;

FIG. 3B illustrates one detailed example of the inode block pointer table of FIG. 3A;

FIG. 4 illustrates the organization of objects within the protected RAM filesystem of FIG. 2 as a filesystem tree;

FIG. 5 illustrates a flow chart of a method for invoking a filesystem protection scheme by remapping filesystem RAM using page table entries;

FIG. 6 illustrates a flow chart of a method for remapping filesystem RAM using page table entries for a write operation on filesystem data;

FIG. 7 illustrates a flow chart of a method for performing a write operation on filesystem data in a protected RAM filesystem;

FIG. 8A illustrates page table entries with a read/write flag for a protected RAM filesystem; and

FIG. 8B illustrates the remapping of page table entries during a write operation on filesystem data.

### DETAILED DESCRIPTION

Reference will now be made in detail to embodiments and implementations, examples of which are illustrated in the accompanying drawings. Wherever possible, the same reference numbers will be used throughout the drawings to refer to the same or like parts.

A. Overview

The following techniques overcome the disadvantages of typical RAM filesystems and provide a protected RAM filesystem that protects filesystem data from corruption by errant writes in an operating system or kernel. In the following description, the techniques are disclosed for a protected, persistent RAM filesystem (“protected RAM filesystem”) in the Linux kernel. Nevertheless, the following techniques can be implemented in other types of kernels such as the Unix® kernel. Furthermore, in the following description, the protected RAM filesystem is also referred to as (“PRAMFS”).

According to one example, a computing system comprises at least one RAM and a processor. The RAM includes a storage location containing filesystem data with associated page table entries. The page table entries are initially set such that the filesystem data is in read-only mode. In order to perform a write into the filesystem data or filesystem, the processor implements a protection scheme in which the filesystem data is mapped for write access by modifying a read/write flag of a page table entry for write access. For instance, the processor can set the read/write flag for write access (“w”) and perform a write operation on the file system data and then set or clear the read/write flag back to read-only access (“r”). In this manner, the filesystem is protected from write operations except when an actual write operation is required for the filesystem. The filesystem can prevent other processes from performing a write operation on filesystem data unless it invokes the protection schemes techniques disclosed herein.

Additionally, the following techniques implement a protected RAM filesystem without using disk caches that avoids page and buffer caching of filesystem. Caching filesystem data in this manner exposes the filesystem data to errant writes by the operating system or kernel. Thus, the protected RAM filesystem disclosed herein avoids this type of caching, thereby providing a more efficient access to filesystem data and protection from errant writes. Furthermore, the protected RAM filesystem disclosed herein provides advantages over disk-based media filesystems by avoiding costly features such as block groups. This reduces filesystem complexity and in turn increases the efficient use of memory space.

The following techniques thus improve reliability, security, and integrity of private and personal information contained in a RAM filesystem. Furthermore, the following techniques can be implemented personal computing devices, cellular communication devices, personal data assistances, and other like devices having RAM filesystems. For instance, systems that store user data, such as address book data, in a battery-backed static random access memory (SRAM) can use this feature to guarantee filesystem persistence across system reboots and power cycles, and to protect that data from errant writes.

B. Exemplary Computing System

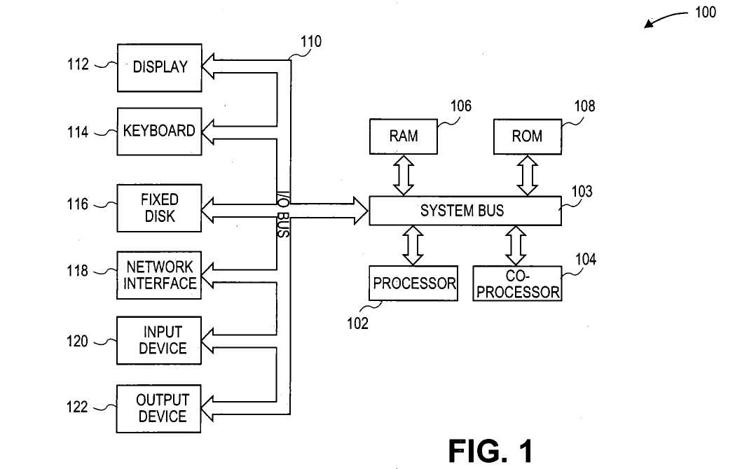

FIG. 1 illustrates an exemplary computing system 100 for providing a protected RAM filesystem. Computing system 100 includes a plurality of components all interconnected via a system bus 103 and input/output (I/O) bus 110. These busses may be, for example, a bi-directional system bus that connects the components for computing system 100. For example, system bus 103 may contain thirty-two address lines for addressing a random access memory RAM 106 and thirty-two bit data lines for transferring data among the components. Alternatively, multiplex data/address lines may be used instead of separate data and address lines.

Computing system 100 includes a processor 102 and co-processor 104 connected to RAM 106 and read-only memory ROM 108 via system bus 103. These processors may be a microprocessor such as the Pentium® family microprocessors manufactured by Intel® Corporation. However, any other suitable microprocessor, micro-, mini-, or mainframe computer processor may be used. As described in further detail below, RAM 106 can be mounted with a filesystem that protects filesystem data from corruption by errant writes in an operating system or kernel. RAM 106 can thus be loaded with operating system software including an operating system kernel. ROM 108 can contain system configuration data and basic input output system (BIOS) data, which can be loaded into RAM 106.

Processor 102 and co-processor 104 are coupled to a plurality of input/output (I/O) devices via I/O bus 110. Examples of such I/O devices include display 112, keyboard, 114, fixed disk 116, network interface 118, input device 120, and output device 122. Other I/O devices that may be coupled to I/O bus 110 include compact disc (CD) or digital video disc (DVD) drives. Additionally, other storage medias including flash memory, electrically erasable programmable read-only memory (EEPROM), dynamic random access memory (DRAM), or other like memory medias may be coupled to I/O bus 110. In this example, system bus 103 may receive inputs from any of the I/O devices coupled to I/O bus 110.

Computing system 100 may be controlled by operating system software, which includes a file management system, such as, for example, a kernel having a virtual filesystem (VFS). The kernel may be part of the operating system software and can mount a protected filesystem in a non-volatile storage device such as RAM 106. Additionally, the kernel may be configured to cause processors 102 or 104 to execute various functions that protect filesystem data from corruption by errant writes in the kernel as detailed below.

C. Protected RAM Filesystem

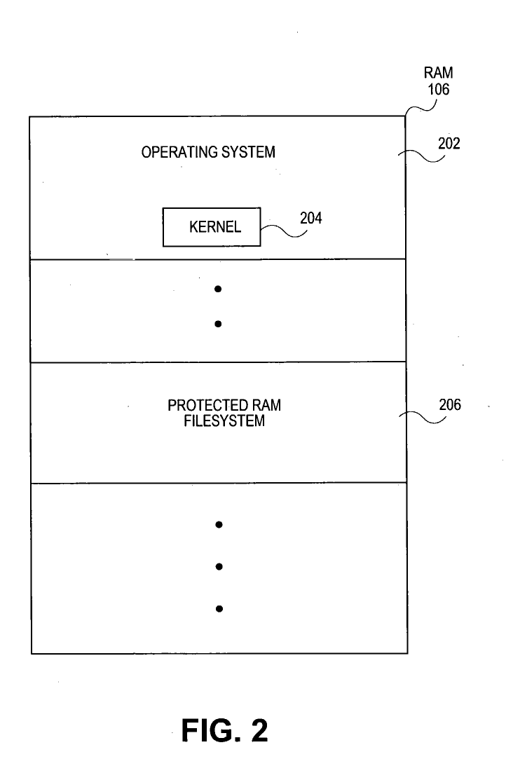

FIG. 2 illustrates one example of random access memory (RAM) 106 for computing system 100 of FIG. 1. In this example, RAM 106 is non-volatile, battery-backed memory device that operates as input/output (I/O) memory providing page table mappings for access by a central processing unit (CPU) such as processor 102 or co-processor 104. As I/O memory, RAM 106 may be excluded from being part of system memory. Other types of memory devices can be used that support standard filesystem application program interfaces (API). In the following examples, RAM 106 can maintain RAM filesystem pages in a write-protected state for a protected RAM filesystem 206, except during filesystem write operations. As detailed below, during write operations, RAM 106 can minimize exposure to errant writes to filesystem data in protected RAM filesystem 206. This type of filesystem can remain intact between system reboots and power cycles.

Referring to FIG. 2, RAM 106 includes operating system 202 having kernel 204, and protected RAM filesystem 206. Operating system 202 includes a basic set of programs to perform basic functions for computing system 100. For purposes of explanation, operating system 202 is a Unix-like operating system such as the Linux operating system. However, the following filesystem protection techniques can be implemented for other operating systems such as the Windows® Family of operating systems. For a Unix-like operating system, RAM 106 is partitioned into fixed blocks of memory referred to as “page frames” or “pages.” Pages occupy 4 Kbytes or 8 Kbytes of physical or virtual memory space in RAM 106. Thus, RAM 106 includes page table entries for processors 102 or 104 to manage pages in RAM 106.

Kernel 204 operates in kernel mode and acts as a process manager for computing system 100. It is responsible for managing and handling system calls from processor 102 or 104 to access directories or files of a filesystem in computing system 100. In particular, kernel 204 operates with a virtual filesystem (VFS) that allows disk partitions to be mounted in RAM 106 that supports multiple types of filesystems. Kernel 204 thus contains information that allows the VFS to handle system calls in accessing the different types of filesystems. For instance, the VFS can support multiple types of filesystems such EXT2, EXT3, and the protected RAM filesystem 206 disclosed herein.

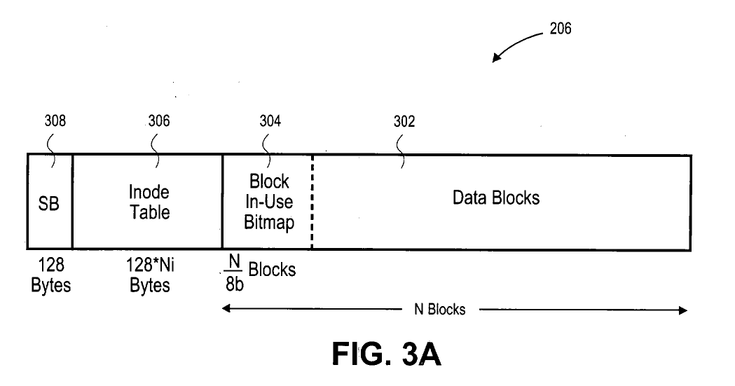

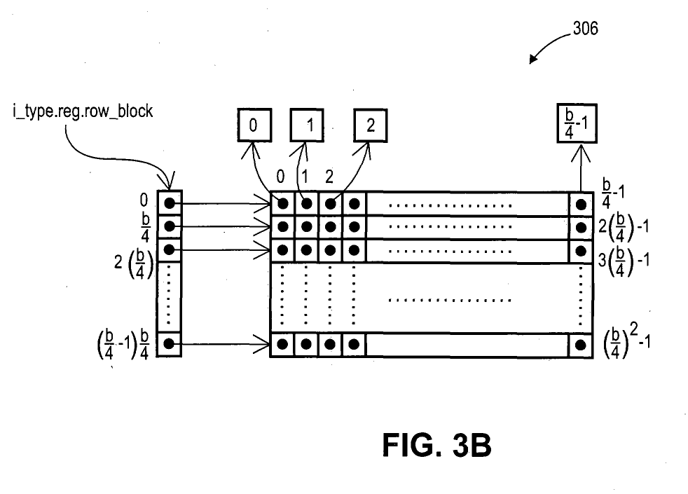

Referring to FIG. 2, kernel 204 is configured to manage and handle protected RAM filesystem 206 which can be mounted within RAM 106. Protected RAM filesystem 206 can be a unique filesystem relating to information that can be protected from errant writes in computing system 100. In particular, in order to achieve such protection, protected RAM filesystem 206 contains filesystem data such as data structures used by kernel 204 to manage and handle filesystem 206 that is mounted in RAM 106. These data structures represent objects in a common file model capable of representing multiple types of filesystems. These objects are depicted in FIGS. 3A and 3B and shown as a filesystem tree in FIG. 4. As described in further detail, kernel 204 can be configured such that the filesystem data objects in protected RAM filesystem 206 is protected from corruption by errant writes or write operations in operating system 202 or kernel 204.

1. Data Objects Layout

FIG. 3A illustrates one detailed example of the protected RAM filesystem 206 of FIG. 2 partitioned with various object blocks. In this example, protected RAM filesystem 206 is mounted in RAM 106 and is not attached to a block device. Such a filesystem can be mounted using a Linux command such as “mount” with a mount point entry, e.g., a directory or filesystem name, and —options. The filesystem can be accessed via the mount point. The “options” can contain information that dictates where to locate or find protected RAM filesystem 206 in RAM 106. Specifically, with a mount command, kernel 204 performs an I/O remap function that creates page table entries for protected RAM filesystem 206 in RAM 106. While mounted in RAM 106, computing system 100 allows operating system 202 or kernel 204 to perform updates to filesystem data in protected RAM filesystem 206 without errant writes from occurring. Protected RAM filesystem 206 can also be unmounted in RAM 106 to free memory space in RAM 106.

Referring to FIG. 3A, one example is shown of allocating protected RAM filesystem 206 in RAM 106. In this example, protected RAM filesystem 206 includes a superblock (“SB”) 308, inode block pointer table (“Inode table”) 306, block in-use bitmap 304, and data blocks 302. Super block 308 is 128 bytes long and is located at beginning of protected RAM filesystem 206. This block is not repeated.

Super block 308 includes information that pertains to the entire protected RAM filesystem 206. For example, such information includes the block size of the protected RAM filesystem 206 in bytes, the total number of inodes and blocks (Ni and N), a count of the current free inodes and data blocks, and etc. An exemplary PRAMFS or protected RAM filesystem 206 super block structure is described below:

```
#define PRAM_SB_SIZE 128 // must be power of two
#define PRAM_SB_BITS 7
typedef unsigned long pram_off_t;
/*
  * Structure of the super block in PRAMFS
  */
struct pram_super_block {
    _u32 s_size; /* total size of fs in bytes */
    _u32 s_blocksize; /* blocksize in bytes */
    _u32 s_features; /* feature flags */
    _u32 s_inodes_count; /* total inodes count (used or free) */
    _u32 s_free_inodes_count;/* free inodes count */
    _u32 s_free_inode_hint; /* start hint for locating free inodes */
    _u32 s_blocks_count; /* total data blocks count (used or free) */
    _u32 s_free_blocks_count;/* free data blocks count */
    _u32 s_free_blocknr_hint;/* free data blocks count */
    pram_off_t s_bitmap_start; /* data block in-use bitmap location */
    _u32 s_bitmap_blocks;/* size of bitmap in number of blocks */
    _u32 s_mtime; /* Mount time */
    _u32 s_wtime; /* Write time */
    _u32 s_rev_level; /* Revision level */
    _u16 s_magic; /* Magic signature */
    _u16 s_state; /* File system state */
    _u16 s_errors; /* Behaviour when detecting errors */
    char s_volume_name[16]; /* volume name */
    _u32 s_sum; /* checksum of this sb, including padding */
} ;
```

Regarding the exemplary super block structure above, the data type pram_off_t is an offset pointer type for PRAMFS or protected RAM filesystem 206. Such an offset is simply a 32-bit offset from the beginning of the protected RAM filesystem 206 and are used to locate data objects in the filesystem such as SB 308, inode table 306, block in-use bitmap 304, and data blocks 302.

Inode table 306 includes Ni inodes, and each inode is 128 bytes long. Thus, in this example inode table 306 is 128*Ni bytes in size. The number of inodes can be calculated such that the end of the table occurs on a block boundary. In this example, the size of inode table 306 is fixed. In particular, the maximum number of inodes that can be allocated in inode table 306 is Ni, which should remain fixed for protected RAM filesystem 206.

The inode objects within inode table 306 include information about specific files in protected RAM filesystem 206. Such information includes the type of file (e.g., regular file, directory file, device node, socket, etc.), the owner and group ID of files, number of hard links to files, the size of files in bytes, number of blocks containing the file data, creation and last access time, etc regarding files. An exemplary PRAMFS or protected RAM filesystem 206 inode structure is described below:

#define PRAM_INODE_SIZE 128 // must be power of two #define PRAM_INODE_BITS 7

```
/*
  * Structure of an inode in PRAMFS
  */
struct pram_inode {
    pram_off_t i_next; /* next inode in this directory */
    pram_off_t i_prev; /* previous inode in this directory */
    _u32 i_uid; /* Owner Uid */
    _u32 i_gid; /* Group Id */
    _u16 i_mode; /* File mode */
    _u16 i_links_count; /* Links count */
    _u32 i_blocks; /* Blocks count */
    _u32 i_size; /* Size of data in bytes */
    _u32 i_atime; /* Access time */
    _u32 i_ctime; /* Creation time */
    _u32 i_mtime; /* Modification time */
    _u32 i_dtime; /* Deletion Time */
    union {
        struct {
            /*
              * ptr to row block of 2D block pointer array,
              * file block #'s 0 to (blocksize/4)\hat{ }2 − 1.
              */
            pram_off_t row_block;
        } reg; // regular file or symlink inode
        struct {
            pram_off_t head; /* first inode in this directory */
            pram_off_t tail; /* last inode in this directory */
        } dir; // directory inode
        struct {
            pram_off_t ino; /* hard link destination (inode) */
        } hlink; // hard link inode
        struct {
            _u32 rdev; /* major/minor # */
        } dev; // device inode
    } i_type;
    _u32 i_sum; /* checksum of this inode */
    /* zero-terminated name, padded to inode size */
    char i_name[0];
};
```

Regarding the above exemplary inode structure, the valid elements of the union for the i_type union member depend on the file types as contained in i_mode. For instance, a directory file has valid information in i_type.dir, and the other elements of the union are invalid. In PRAMFS or protected RAM filesystem 206, the inode number of an inode is simply the absolute offset (pram_off_t) of that inode within the protected RAM filesystem 206.

Data blocks 302 occupy the remaining space in protected RAM filesystem 206. Data blocks 302 include data blocks for filesystem data and the in-use bitmap illustrated in FIG. 3B. As shown in FIG. 3B, the block size in bytes, and N is the total number of data blocks. Like Ni, N is fixed, that is, once the filesystem is created, the maximum number of data blocks that can be allocated is fixed.

In PRAMFS or protected RAM filesystem 206 only regular files have file system data—directories do not have data blocks. The inode field i_type.reg.row block points to the start of a 2-dimensional table of data block pointers. A single block is allocated for the row block, and therefore contains b/4 32-bit pointers that point to up to b/4 column blocks. Each column block holds up to b/4 pointers to data blocks. In this manner, a regular file can contain up to (b/4)² data blocks, or b³/16 bytes of data. For those familiar with the EXT2 filesystem, i_type.reg.row block is equivalent to the i_b[13] entry in the EXT2 inode structure. The EXT2 inode's i_block[0-11] entries point directly to data blocks, the reason being that, for small files, the first 12 data blocks can be located in a single disk seek.

For PRAMFS or protected RAM filesystem 206 however, there is no speed penalty for random access, so direct pointers to data blocks are not necessary, and hence simplifies the methods for locating data blocks. Also, higher order tables (such as EXT2's 3-dimensional i_block[14]) are not deemed necessary in PRAMFS or protected RAM filesystem 206 because it is not envisioned that so much persistent RAM would be available to hold such large files.

It should be noted, regarding block numbers, an offset pointer to a block is sometimes referred to as a logical block number. Given a block index from 0 to N-1, an index can be easily converted into a logical block number. For instance, a logical block number is the start offset of data blocks plus the index times the blocksize, or s_bitmap_start+(index * b). However when accessing data blocks for a file, a file block number, which is the relative position of the block inside the file, can be used. To find an absolute logical block number corresponding to a file block index from 0 to (b/4)²−1, the inode's 2-dimensional block pointer table can be used. For instance, if looking for the block at file block index 359 and the blocksize is b=1024 (i.e., a single block can hold 256 logical block numbers), the logical block number for file block index 359 would be located at i_type.reg.row block [1][103]—that is, entry 103 within the second column block. This algorithm or process can be accomplished using a function that takes as arguments the inode and the file block index and returns the corresponding logical block number.

Referring to FIG. 3B, the organization of inode table 306 is shown. Arrows in FIG. 3B represent pram_off_t pointers, and entries in the column blocks are marked with their file block index, and are pointing to data blocks assigned to them. To allocate a new block, a search is made for the first cleared bit in the block in-use bitmap 304. The located bit number is also the logical block index of the located free block. The bit is then set in the in-use bitmap to mark the corresponding block as in use. This algorithm or process can implemented using a in the function that returns the logical block index of the block that was just allocated.

2. Directory Structure

FIG. 4 illustrates the organization of objects within the protected RAM filesystem 206 of FIG. 2 as a filesystem tree. In one example, the filesystem tree can represent the inode objects in protected RAM filesystem 206. These objects within a directory can be linked together in a doubly-linked list. Thus, as described in further detail below, each of these objects can have a set of head and tail pointers and next and previous pointers to form two types of linked lists used by kernel 204 to manage protected RAM filesystem 206. Other linked lists can be used that point to associated data block objects for each inode.

Referring to FIG. 4, the filesystem tree includes a root “/” directory inode 402. In this example, root inode 402 contains a plurality of directory inodes (directory₁ inode 404 though directory_{N} inode 406). Root inode 402 can also contain any combination of directory inodes and file inodes. Root inode 402 includes a head pointer (“head ptr”) pointing to its first directory inode (directory₁ inode 404) and a tail pointer pointing to its last directory inode (directory_{N} inode 406). Each directory inode can include a plurality of files having associated file inodes.

For instance, directory₁ inode 404 contains a plurality of files having associated file inodes (file₁ inode 408 through file_{N} inode 410) and directory_{N} inode 406 contains a plurality of files having associated file inodes (file₁ inode 412 through file_{N} inode 414). Each of these directory inodes includes head and tail pointers (“head ptr” and “tail ptr”) point to respective first file inodes and last file inodes and a “next ptr” pointing to its next directory inode and a “previous ptr” pointing to its previous directory inode. Each file inode within the directory inodes also includes next and previous pointer respectively. This filesystem tree is exemplary of the organization of the objects in protected RAM filesystem 206 and therefore other organization of objects can be implemented with protected RAM filesystem 206.

It should be noted that other filesystem implementations, such as EXT2, use objects called directory entries, or “dentries”, to associate file names to inodes, and these dentries are located in data blocks owned by a parent directory. For instance, in EXT2 a dentry holds the file name, the inode number to associate the file with, and the file type, and these dentries are stored in data blocks owned by the parent directory. In PRAMFS or protected RAM filesystem 206 a directory inode's do not need to own any data blocks, because all dentry information is contained within the inode's themselves.

D. Protected RAM FilesVstem Methods

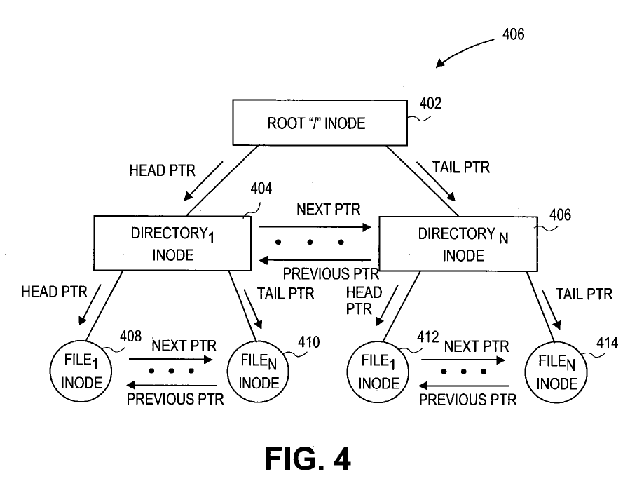

FIGS. 5 through 8B illustrate methods of protecting filesystem data from errant writes in an operating system kernel. For purposes of explanation, the following methods refer to computing system 100.

FIG. 5 illustrates a flow chart of a method 500 for invoking a filesystem protection scheme by remapping filesystem RAM by modifying page table entries. Initially, protected RAM filesystem 206 is mounted in RAM 106 to create page table entries (step 502). For example, the Linux “mount” command can be implemented in which kernel 204 performs an I/O remap function that creates page table entries for protected RAM filesystem 206 in RAM 106.

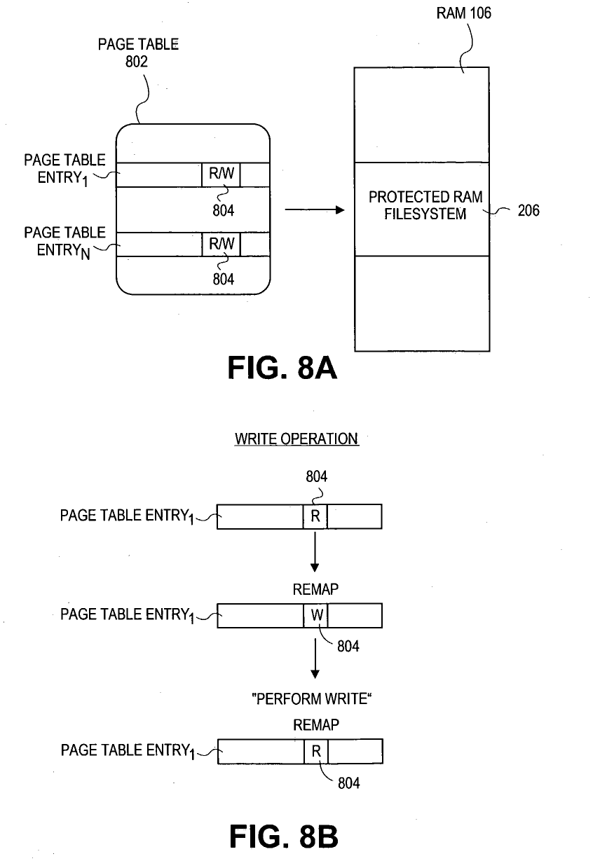

Referring to FIG. 8A, a plurality of page table entries (page table entry₁ through page table entry_{N}) are created in a page table 802 that correspond to pages of protected RAM filesystem 206 in RAM 106 (step 504). Each page table entry includes a read/write flag that indicates a read-only mode or write-enable mode for pages of protected RAM filesystem 206. If read-only mode is asserted, pages can only be read in protected RAM filesystem 206. If write-enable is asserted, filesystem data can be written into pages or written over in pages of protected RAM filesystem 206.

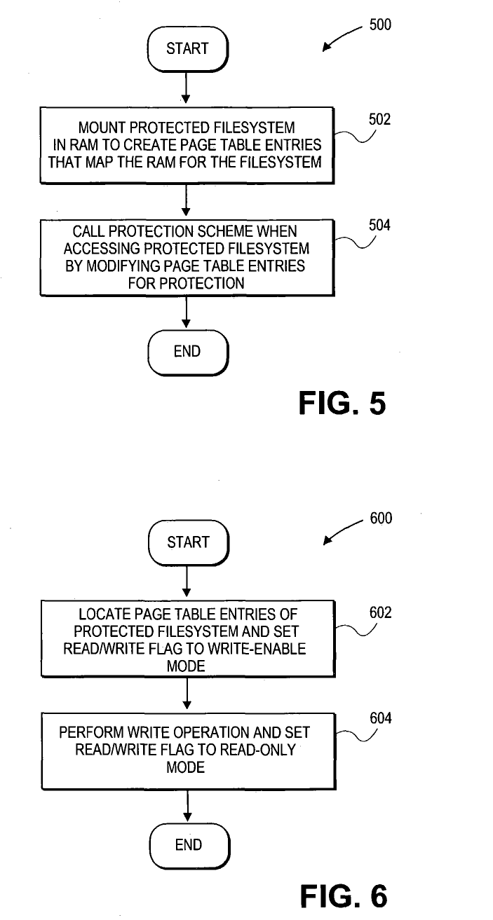

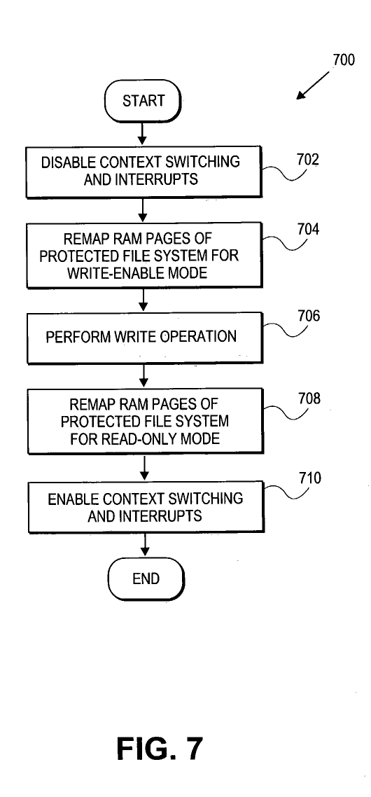

Next, if protected RAM filesystem 206 is to be accessed, e.g., to perform a write operation, a special call is made to implement a protection scheme for protected RAM filesystem 206. This protection scheme remaps filesystem RAM by modifying page table entries for protection such that any change or write to filesystem data in protected RAM filesystem 206 is performed within a limited window of access to minimize errant writes to filesystem data. The above method can be implemented without using disk caching and to access protected RAM filesystem 206 by invoking special function calls such as those described below regarding FIGS. 6 and 7.

FIG. 6 illustrates a flow chart of a method 600 for remapping filesystem RAM using page table entries for a write operation on filesystem data. To start, page table entries are located for protected RAM filesystem 206 and the read/write flag is modified for read-only mode (step 602). For example, referring to FIG. 8B, the read/write flag of page table entry₁ is initially set as read-only “R” and modified as write-enable “W”. The following is exemplary code to implement this step of remapping filesystem data by modifying page table entries for write-enable mode, which can use any number of pointers to point to the page table entries.

```
/*
  * Change the writeable flag for the pte mapping the given address.
  * Hold init_mm.page_table_lock
  */
static void pram_page_writeable(unsigned long addr, int rw)
{
    pgd_t *pgdp;
    pmd_t *pmdp;
    pte_t *ptep;
    pgdp = pgd_offset_k(addr);
    if (!pgd_none(*pgdp)) {
        pmdp = pmd_offset(pgdp, addr);
        if (!pmd_none(*pmdp)) {
            pte_t pte;
            ptep = pte_offset(pmdp, addr);
            pte = *ptep;
            if (pte_present(pte)) {
                pte = rw ? pte_mkwrite(pte) :
                    pte_wrprotect(pte);
                set_pte(ptep, pte);
            }
        }
    }
}
// Hold init_mm.page_table_lock
void pram_writeable(void * vaddr, unsigned long size, int rw)
{
    unsigned long addr = (unsigned long)vaddr & PAGE_MASK;
      unsigned long end = (unsigned long)vaddr + size;
      do {
        pram_page_writeable(addr, rw);
        addr += PAGE_SIZE;
      } while (addr && (addr < end));
      flush_tlb_all( );
}
```

Next, the write operation is performed and afterwards the read/write flag is modified back to read-only (step 604). A write operation can be, e.g., creating a new inode r a new data block in protected RAM filesystem 206. For instance, creating a new file in the filesystem provokes a write operation of an “node” into protected RAM filesystem 206. As shown in FIG. 8B, after a write operation is performed, the read read/write flag for page table entry₁ is modified back to read-only. In this manner, all writes to filesystem data in protected filesystem 206 can only be performed in a limited window using the above method because, after the write operation, filesystem data is remapped to read-only mode. Thus, errant writes to filesystem data in PRAMFS or protected RAM filesystem 206 is minimized.

FIG. 7 illustrates a flow chart of a method 700 for performing a write operation on filesystem data in PRAMFS or protected RAM filesystem 206. Initially, context switching and interrupts are disabled (step 702). For example, kernel 204 can obtain a “spinlock” on protected RAM filesystem 206 to prevent processors 102 or 104 from servicing another process while a write operation into protected RAM filesystem 206 is in progress. The following is exemplary code to obtain a spinlock.

```
/*
  * Write protection for pramfs inodes. First grab the page-table spin-
  lock,
  * then remap the pages that contain the inode as read/write.
  */
#define pram_lock_inode(i) {\
    spin_lock_irqsave(&init_mm.page_table_lock, flags);\
    pram_writeable((i), PRAM_INODE_SIZE, 1);\
}
```

Another manner of disabling context switching and interrupts is by modifying the processor control registers or other related flags accordingly. RAM pages of protected filesystem 206 is remapped by modifying page table entries for write-enable mode (step 704). The method 600 regarding FIG. 6 can be used to implement this remapping of RAM pages. Next, a write operation is performed (step 706). To perform a write operation, a pointer to an inode within protected RAM filesystem 206 is obtained. The following is exemplary code in obtaining an inode pointer for a write operation.

```
/* Calculate and return a pointer to an inode on the RAM media.
  *
  * inode->i_sb->u.pram_sb.virt_addr is a pointer to the super
  * block on the RAM media, this is also the mapped linear
  * base address of the RAM media. It was mapped using a
  * function similar to ioremap( ), except that the RAM
  * was mapped read-only.
  */
static inline struct pram_inode *
pram_get_inode(struct super_block * sb, ino_t ino)
{
    struct pram_super_block * psb = inode->i_sb->u.pram_{—}
    sb.virt_addr;
    return ino ? (struct pram_inode *)((void*)psb + ino) : NULL;
}
/*
```

The following is exemplary code to perform a write operation for the inode.

```
/*
  * This is an example write_inode method of struct super_operations
  * for the pramfs. Notice that there are no references to buffer
  * heads or page cache. In fact no pramfs data ever exists in the
  * buffer or page caches, they are totally bypassed.
  *
  * Notice also that the do_sync flag is ignored. The pramfs I/O
  * operations are always synchronous, because the RAM media
  * that makes up the pramfs is assumed to be fast SRAM or DRAM.
  */
static int pram_write_inode(struct inode * inode, int do_sync)
{
    struct pram_inode * pi;
    unsigned long flags;
    lock_kernel( );
    /* get pointer to the pramfs inode in the RAM media */
    pi = pram_get_inode(inode->i_sb, inode->i_ino);
    /*
      * make the pramfs inode pages read/write, and hold a spin-lock
      * with interrupts disabled.
      */
    pram_lock_inode(pi);
    /*
      * update contents of pramfs inode. We are guaranteed that we
      * will not be interrupted or preempted while we are writing
      * to the inode.
      */
    pi->i_ino = inode->i_ino;
    pi->i_mode = inode->i_mode;
    pi->i_uid = inode->i_uid;
    pi->i_gid = inode->i_gid;
    pi->i_links_count = inode->i_nlink;
    pi->i_size = inode->i_size;
    pi->i_blocks = inode->i_blocks;
    pi->i_atime = inode->i_atime;
    pi->i_ctime = inode->i_ctime;
    pi->i_mtime = inode->i_mtime;
    if (S_ISCHR(inode->i_mode) ∥ S_ISBLK(inode->i_mode))
        pi->i_type.dev.rdev = inode->i_rdev;
    /*
      * make the pramfs inode pages read-only again, release the
      * spin-lock and reenable interrupts.
      */
    pram_unlock_inode(pi);
    unlock_kernel( );
    return 0;
}
```

Next, the context switching and interrupts are enabled (step 710). This can be obtained by releasing the spin lock in read-only mode. The following is exemplary code for releasing the spin lock:

```
/*
  * Remap the pages that contain the inode as read-only again, and release
  * the page-table spin-lock.
  */
#define pram_unlock_inode(i) {\
    pram_writeable((i), PRAM_INODE_SIZE, 0);\
    spin_unlock_irqrestore(&init_mm.page_table_lock, flags);\
}
```

Thus, a protected RAM filesystem has been described. In the foregoing specification, the invention has been described with reference to specific exemplary embodiments and implementations thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A computing system comprising:
at least one random access memory (RAM), the RAM having a storage location containing filesystem data with associated page table entries, each page table entry having a read/write flag for the filesystem data, the filesystem data being initially mapped for read-only access; and
a processor configured to remap the filesystem data for write access by modifying the read/write flag of the page table entries; to perform a write operation on the filesystem data during write access, and to remap the filesystem data back for read-only access by modifying the read/write flag of the page table entries.

2. The computing system of claim 1, wherein the processor is to mount the filesystem data in the memory with a protection scheme.

3. The computing system of claim 1, wherein the processor is to modify page table entries to protect the filesystem data.

4. The computing system of claim 3, wherein the processor is to modify a read/write flag in at least one page table entry to protect the filesystem data.

5. The computing system of claim 1, wherein the filesystem data is Linux filesystem data.

6. A computing system comprising:
at least one random access memory (RAM); and
a filesystem mounted in the RAM to manage filesystem data, the filesystem protecting the filesystem data from errant writes by modifying at least one page table entry associated with the filesystem data without using a disk cache.

7. The computing system of claim 6, wherein filesystem includes a super block section, inode table section, block in-use bitmap section, and data blocks section.

8. The computing system of claim 6, wherein the each page table entry includes a read/write flag.

9. The computing system of claim 6, wherein the filesystem modifies the read/write flag to write-enable mode during a write operation on the filesystem data.

10. The computing system of claim 9, wherein the filesystem modifies the read/write flat to read-enable after the write operation on the filesystem data.

11. A computer-implemented method comprising:
mounting a protected filesystem to manage filesystem data in a random access memory (RAM);
calling a protection function when accessing the filesystem data by modifying page table entries to the filesystem data.

12. The method of claim 11, wherein the filesystem data is initially mapped for read-only access.

13. The method of claim 12, wherein calling the protection function comprises:
locating page table entries for the protected filesystem;
setting a read/write flag for the located page table entries to write-enable mode;
perform a write operation; and
setting the read/write flay for the located page table entries to read-only mode.

14. A method for protect filesystem data in a protected random access memory (RAM) filesystem, the RAM having RAM pages associated with the filesystem data, the method comprising:
disabling context switching and interrupts when accessing the protected RAM filesystem;
remapping the RAM pages of the protected RAM filesystem for write-enable mode;
performing a write operation on the filesystem data;
remapping the RAM pages of the protected RAM filesystem for read-only mode; and
enabling context switching and interrupts after accessing the protected RAM filesystem.

15. The method of claim 14, wherein remapping the RAM pages for write-enable mode includes:
modifying a read/write flag in the RAM pages for the write-enable mode.

16. The method of claim 15, wherein remapping the RAM pages for read-only mode includes:
modifying a read/write flag in the RAM pages for the read-only mode.

17. The method of claim 15, wherein the read/write flay in the RAM pages is initially set for read-only mode.

18. A computing system comprising:
at least one random access memory (RAM), the RAM having a protected RAM filesystem to manage filesystem data, the filesystem data having RAM pages associated with the filesystem data; and
a central processing unit to disable context switching and interrupts when accessing the protected RAM filesystem, to remap the RAM pages of the protected RAM filesystem for write-enable mode, to perform a write operation on the filesystem data, and to remap the RAM pages of the protected RAM filesystem for read-only mode; and to enable context switching and interrupts after accessing the protected RAM filesystem.

19. The computing system of claim 18, wherein the central processing unit modifies a read/write flag in the RAM pages for the write-enable mode.

20. The computing system of claim 19, wherein the central processing unit modifies a read/write flag in the RAM pages for the read-only mode.

21. The computing system of claim 19, wherein the read/write flag in the RAM pages is initially set for read-only mode.
